(19) United States
(12) Patent Application Publication
(10) Pub. No.: US 2006/0010111 A1
(43) Pub. Date: Jan. 12, 2006

(54) Methods to adapt search results provided by an integrated network-based media/search engine based on user lifestyle

(75) Inventors: Courtney P. Jones, Ft. Myers, FL (US); Michael R. Roe, Neptune Beach, FL (US)

Correspondence Address: HAHN LOESER & PARKS, LLP, One GOJO Plaza, Suite 300, AKRON, OH, 44311-1076, US

(73) Assignee: Blu Ventures, LLC

(21) Appl. No.: 11/066,623

(22) Filed: Feb. 25, 2005

Related U.S. Application Data
(63) Continuation-in-part of application No. 10/664,407, filed on Sep. 19, 2003.
(60) Provisional application No. 60/547,765, filed on Feb. 25, 2004.
(60) Provisional application No. 60/588,565, filed on Jul. 16, 2004.
(60) Provisional application No. 60/588,934, filed on Jul. 16, 2004.
(60) Provisional application No. 60/588,567, filed on Jul. 16, 2004.
(60) Provisional application No. 60/588,568, filed on Jul. 16, 2004.

(51) Int. Cl. G06F 17/30; G06F 15/00

(52) U.S. Cl. 707/3; 715/501.1

(57) ABSTRACT

Methods to adapt a user interface view, provided by an integrated media/search web site via a global informational network, based on a user's lifestyle are disclosed. The methods include populating a user interface view of the integrated web site with a first set of links to the global informational network, wherein the integrated web site integrates a streaming digital media provider station with a global search engine. A user selects a link from the first set of links or performs a key word search using the global search engine. The user interface view is then re-populated with an updated set of links to the global informational network based on demographic and psychographic associations made by the global search engine in response to at least the most recently selected link, the most recent key word search, or the most recent streaming media content. If a new link or a new key word search is performed, the user interface view is again re-populated with an updated set of links. Also, if the streaming media program content from the provider changes, the user interface view is again re-populated with an updated set of links.

### CROSS-REFERENCE TO RELATED APPLICATIONS/INCORPORATION BY REFERENCE

This application claims priority to U.S. patent application Ser. No. 10/664,407, filed on Sep. 19, 2003, U.S. provisional patent application Ser. No. 60/547,765, filed on Feb. 25, 2004, U.S. provisional patent application Ser. No. 60/588,565, filed on Jul. 16, 2004, U.S. provisional patent application Ser. No. 60/588,934, filed on Jul. 16, 2004, U.S. provisional patent application Ser. No. 60/588,567, filed on Jul. 16, 2004 and U.S. provisional patent application Ser. No. 60/588,568, filed on Jul. 16, 2004, which are each incorporated herein by reference in their entirety.

### TECHNICAL FIELD

Certain embodiments of the present invention relate to searching in association with media consumption. More particularly, certain embodiments of the present invention relate to methods and systems to create and adapt search results based on user media selections, web site selections, and possibly collected user demographic and psychographic information.

### BACKGROUND OF THE INVENTION

Traditional media sources, such as media broadcasting sources like radio or television, combine media content (such as entertainment content or news content) with commercial advertising content. Programming content is periodically interrupted by commercial advertising content in units of, typically, 30 seconds and 60 seconds to generate income. A user of the broadcast is forced to wait until the commercial advertising segment is finished before he is able to resume consumption of media programming content.

On the Internet, search engines are used to find sources of information, media content, and advertisers. Advertisers may pay the provider of the search engine to be found and are ranked according to bid, with the highest bid appearing first in a search list on the users PC (personal computer) screen. U.S. Pat. No. 6,269,361 describes such a bidding methodology.

Users enter key search words to perform a search and the search engine provides a list of search results in the form of links to web sites. One of the drawbacks of current search engines is that they typically do not take into consideration any information about the user to provide a better search result that is more pertinent to the user's interests. A search engine may simply “know” that users who have searched for “A” have also searched for “X”, “Y”, and “Z”. Searching today provides mostly sterile and often static listings of URL's that point to sites based on a Boolean search. Results often lack any real relevancy and often, users have to refine and refine to finally get what they are looking for.

Internet media comes in a variety of forms, from images, music, video, audio and other sources, and provides a challenge for combining effective advertising therewith. For example, internet radio stations provide programming content and may allow advertisers to provide “pop-up” icons that a user can click on to go to the web sites of the advertisers. Internet radio stations often require users to subscribe to the radio station in order to access programming content of the radio station. The subscription usually involves paying a fee.

Public broadcasting, such as public radio or TV, typically depends upon corporate or foundation sponsors to generate income. The name of the sponsor associated with a certain programming content is often mentioned at the end of the broadcast of the sponsored program. Also, pleas for donations, in the form of on-air pledge drives, are made to users of public broadcasting to offset the cost of providing programming content. These pledge drives often interrupt programming content for extended periods of time.

Uninterrupted sources of media content are desired by users, leading to the success of cable/satellite TV and radio, and the internet as examples. It would be desirable to allow a consumer of media to receive the benefits of uninterrupted access to media, while allowing search of relevant information via a system accessing the internet or other information system.

Further limitations and disadvantages of conventional, traditional, and proposed approaches to searching information systems and advertising will become apparent to one of skill in the art, through comparison of such systems with the present invention as set forth in the remainder of the present application with reference to the drawings.

### BRIEF SUMMARY OF THE INVENTION

The invention generally relates to the concept of providing search capabilities in connection with the consumption of media of any type, using a system for accessing the media content. A first embodiment of the present invention comprises a method to automatically search a global informational network, based on media content consumed by a user of the network. The method comprises allowing access to and consumption of at least one media content file accessible via the network, and conducting a search of the network based upon at least the media content being consumed by the user. The method provides for display of information relating to the search via a user interface.

A second embodiment of the present invention comprises a method to provide an integrated media/search system via a global informational network, which provides for processing of media content as well as providing search capabilities based on a user's consumption of media, psychographic and demographic information about the user and the users lifestyle. The method comprises providing the integrated system integrates at least one media content file with at least one global search engine via an graphics enabled interface. The search engine populates the user interface view with a first set of links to the global informational network, upon entering at least one first search key word into a key search word text entry box of the user interface view and initiating a first search of the global informational network based on the at least the one first search key word and demographic and psychographic associations made by the global search engine in response to the at least one first search key word and media content consumed by the user.

A system according to the present invention comprises a user interface, providing an integrated media/search engine application in communication with a global informational network. A user consumes media content via the interface, and may input queries to the search engine, wherein the search engine captures and considers demographic and psychographic information based on a user's use of the search engine and based upon the media consumed via the interface. The system may populate the user interface view with links to the global informational network, as well as the consumption of media content. In populating the interface view, the search engine makes utilizes demographic and psychographic associations made by the at least one global search engine in response to the selected links and/or in response to the media program content.

A fourth embodiment of the present invention comprises a method and system to provide an integrated media/search application wherein at least one streaming media source is in communication with the interface and a search engine is accessed via a global informational network through the interface, the search engine providing search results to the interface based on demographic and psychographic associations made by the at least one global search engine in response to the selected links and/or in response to the media program content. The method comprises populating the user interface view with a first set of links to the global informational network in response to the first streaming media content. The method may further comprise re-populating the user interface view with further links to the global informational network based on demographic and psychographic associations made by the global search engine in response to the different streaming media content.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a schematic block diagram of an embodiment of a personal computer (PC) system displaying an integrated, Internet-based media/search (IIM/S) user interface view having an Internet radio station sub-view and a search tool sub-view displayed on a screen of the PC system, in accordance with various aspects of the present invention.

FIG. 2 illustrates a schematic block diagram of an embodiment of a system providing integrated streaming digital media and Internet search capability to the system of FIG. 1, in accordance with various aspects of the present invention.

FIG. 3 is a flowchart of an embodiment of a method to adapt the user interface view of FIG. 1 based on user actions using the system of FIG. 2, in accordance with various aspects of the present invention.

FIG. 4 illustrates a first exemplary embodiment of a IIM/S user interface view provided by the system of FIG. 2, in accordance with various aspects of the present invention.

FIG. 5 illustrates a second exemplary embodiment of a IIM/S user interface view provided by the system of FIG. 2, in accordance with various aspects of the present invention.

FIG. 6 illustrates a third exemplary embodiment of a IIM/S user interface view provided by the system of FIG. 2, in accordance with various aspects of the present invention.

FIG. 7 illustrates a fourth exemplary embodiment of a IIM/S user interface view provided by the system of FIG. 2, in accordance with various aspects of the present invention.

FIG. 8 illustrates a further embodiment of the invention in association with a non-computer device having an interface for consuming media content and for communication with and display of search information from a global information system.

### DETAILED DESCRIPTION OF THE INVENTION

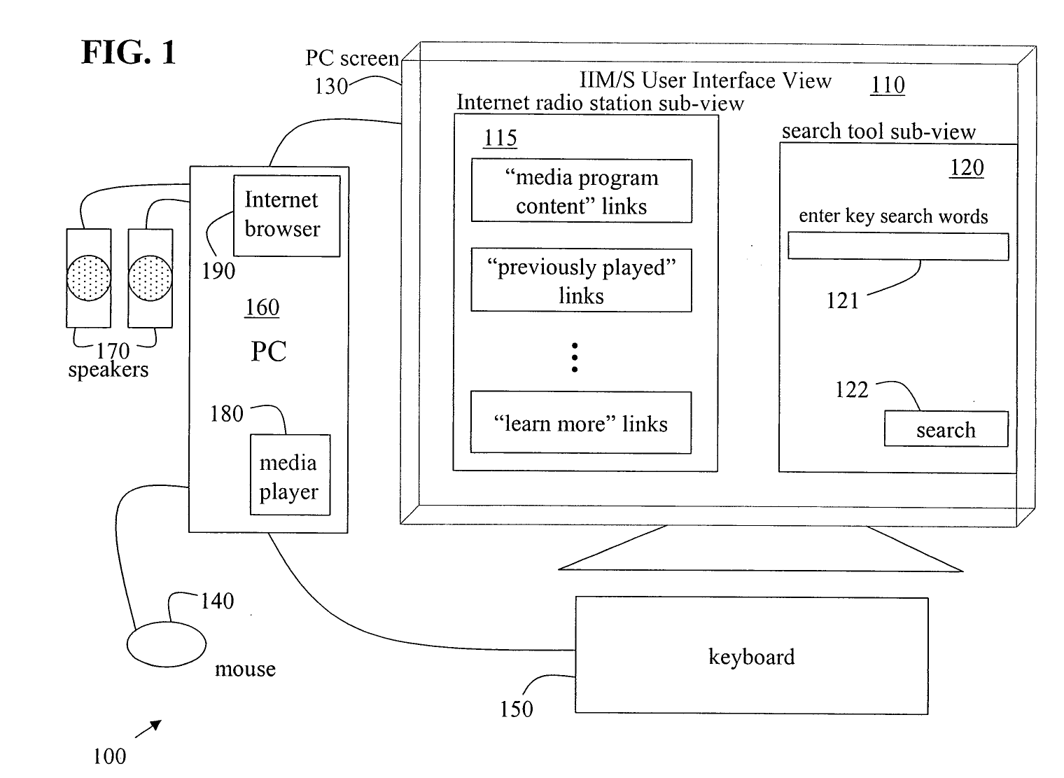

FIG. 1 illustrates a schematic block diagram of an embodiment of a personal computer (PC) system 100 displaying an integrated, Internet-based media/search (IIM/S) user interface view 110 having an Internet radio station sub-view 115 and a search tool sub-view 120 displayed on a screen 130 of the system 100, in accordance with various aspects of the present invention. It should be understood that although the embodiment shows the system and methods of the invention used with a PC, any other suitable device for integration of media consumption with communication to a global information system and search engine application is contemplated in the invention. For example, any existing or future device, application, executable file, computer of any form factor, cellular devices, PDA, digital audio player and/or receiver, television, wireless media receivers, digital media managers and the like are contemplated.

Referring to FIG. 1, in accordance with an embodiment of the present invention, the system 100 may include a screen 130, a mouse (or any other suitable device for controlling and selecting information within the system, such as remote control) 140, a keyboard 150, a processing unit 160, and speakers 170. The screen 130, the mouse (remote control or the like) 140, the keyboard 150, and the speakers 170 each interface to the processing unit 160. The processing unit 160 includes a media player module 180 capable of processing and playing media, such as digital streaming audio and/or streaming video, digital images or audio files, or any other media content. The PC processing unit 160 also includes a browser 190 capable of accessing information via a global information system, such as web addresses on the Internet. In this regard, it should also be understood that the invention contemplates access to media through any suitable system, such as an HTML enabled “browser” device, or any other suitable “browser” language or device, such as php, asp, java, or any system that enables the display of text or graphics via a user interface.

In accordance with an embodiment of the present invention, the media player module 180 comprises a software module residing within the processing unit 160. In accordance with an embodiment of the present invention, the browser 190 comprises a software module residing within the processing unit 160.

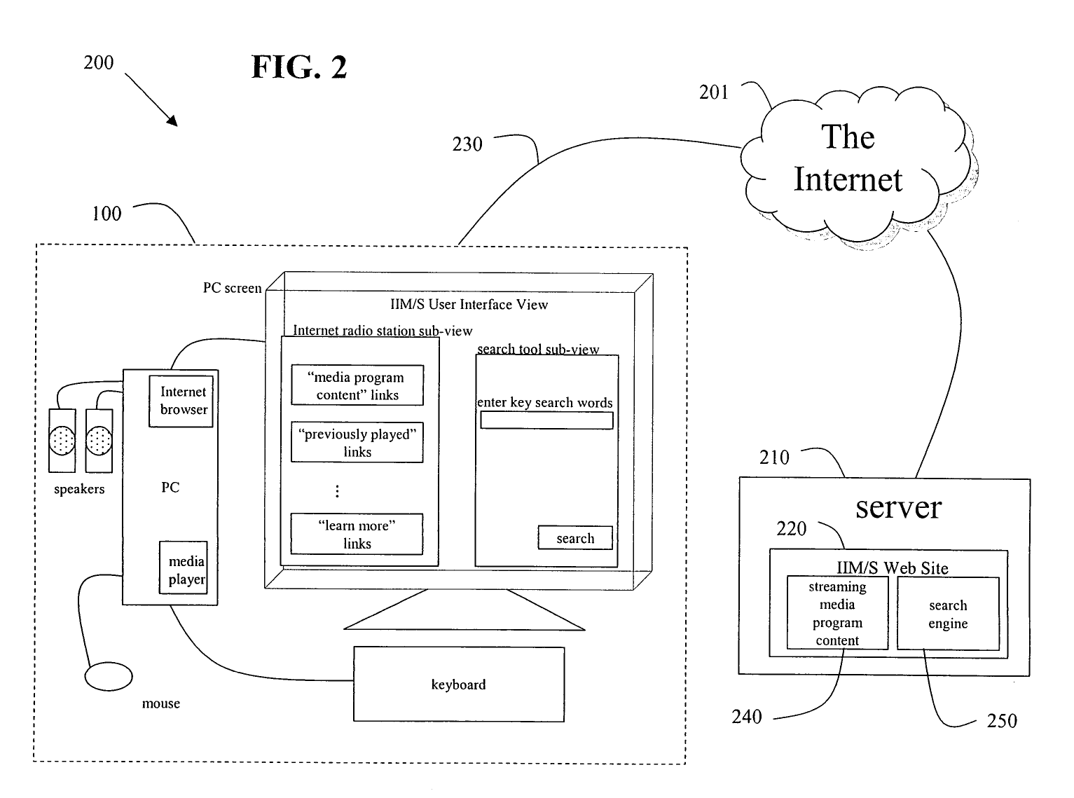

FIG. 2 illustrates a schematic block diagram of an embodiment of a system 200 providing integrated streaming digital media and Internet search capability to the system 100 of FIG. 1, in accordance with various aspects of the present invention. The system 200 comprises the Internet 201 and a server 210. The server 210 interfaces to the Internet 201. The server 210 hosts an IIM/S website 220 which provides the IIM/S user interface view 110 of FIG. 1, in accordance with various aspects of the present invention. This is only an example of the type of system 100 that may be usable to provide the IIM/S user interface view 110.

Referring to FIG. 2, a user of the system 100 may connect to the Internet 201 via traditional means such as a dial-up connection or a cable modem connection 230, for example, and access the IIM/S website 220. The connection to the Internet 201 may be wired or wireless. In accordance with an embodiment of the present invention, the IIM/S website 220 is hosted on the server 210 on the Internet 201 and is configured as an Internet radio station that provides various streaming media program content 240 (such as, for example, music) and various display views (e.g., 110) to the PC system 100 via the established Internet connection. The IIM/S website 220 also comprises an integrated search engine 250 corresponding to the search tool sub-view 120. It should also be understood that the embodiment of an Internet radio station is merely an example of the type of interface with which the invention may be applicable, and the invention is not limited thereto in any manner.

In accordance with various alternative embodiments of the present invention, the Internet 201 may instead comprise some other global informational network. In general, media program content may be any media content, whether streaming or not, with this embodiment using is at least one of streaming digital audio or streaming digital video in the form of, for example, musical pieces (e.g. songs), human discourse (e.g., talk radio), television programs, music videos, news programs, etc.

The IIM/S user interface view 110 provided by the IIM/S website 220 is displayed on the screen 130 of the system 100 to the user. In accordance with an embodiment of the present invention, the IIM/S user interface view 110 includes an Internet radio station sub-view 115 with various link choices (e.g., “media program content” links, “previously played” links, “learn more” links, other links, etc.) and a search tool sub-view 120. The various link choices are provided by the IIM/S website 220 to the system 100. For example, when a user clicks on a “media program content” link, streaming digital media content 240 is routed from the server 210 to the PC 100 via the Internet 201. The media player 180 receives and plays the streaming digital media content 240 (e.g., a musical piece) through the speakers 170.

The “media program content” link choices displayed in the sub-view 115 may include links to individual musical pieces or songs, an album of musical pieces or songs, songs of a particular artist, a category or genre of musical pieces or songs, talk radio shows, news, etc. For example, a first media program content link may be the category of music called “Classic Rock”. When a user clicks on the “Classic Rock” category, streaming digital audio of classic rock music is transmitted from the server 210 to the system 100. Alternatively, when a user clicks on the “Classic Rock” category, another set of links is displayed to the user which provides choices of songs of individual musical artists that the user may select. Other arrangements are possible as well, in accordance with various embodiments of the present invention.

The search tool sub-view 120 includes a text entry area 121 to enter key search words, and a “search” or “go” icon 122 to initiate a search. A user may use the mouse (remote control or the like) 140 or the keyboard 150 of the system 100 to select any of the link choices and to enter key search words in the text entry area 121 to perform a search on the Internet 201. In accordance with an embodiment of the present invention, at least the entire World Wide Web (WWW) is available for searching via the search tool sub-view 120 using the search engine 250.

In accordance with an embodiment of the present invention, the user may use the search engine 250 while listening to the streaming digital media program content without interrupting the streaming digital media program content. The user may proceed to input key search words into the search tool sub-view 120 using, for example, the keyboard 150 in order to look for other web sites on the Internet 201. The web sites that a user may search for may include many different types of web sites that are hosted on the Internet 201, including web sites of advertisers who are sponsors of the Internet radio station.

As an example, referring to FIG. 2, a user of the PC system 100 accesses the IIM/S website 220 (e.g., an Internet radio station) and views the IIM/S user interface view 110. The user then clicks on a “media program content” link, for example, to initiate the reception of streaming digital audio, via the Internet 201, from the server 210 which is hosting the IIM/S website (i.e., the Internet radio station). Once the user is comfortably listening to the selected media program content (which may be, for example, classical music), the user may then begin entering key search words into the search tool sub-view 120 to leisurely search the Internet 201 while listening to the streaming audio.

Also, in accordance with an embodiment of the present invention, the user may click on various link choices in the sub-view 115 while listening to the streaming digital media program content without interrupting the streaming digital media program content. The user may proceed to click on links using, for example, the mouse (remote control or the like) 140 in order to access other web pages of the IIM/S web site 220 or to access other web sites on the Internet 201. The various link choices may include links to streaming media program content, links to other web pages of the IIM/S web site 220, links to other web sites on the global informational network (e.g., the Internet 201), and links to other links.

As an example, referring to FIG. 2, a user of the system 100 accesses the IIM/S website 220 (e.g., an Internet radio station) and views the IIM/S user interface view 110. The user then clicks on a “media program content” link, for example, to initiate the reception of streaming digital audio, via the Internet 201, from the server 210 which is hosting the IIM/S website (i.e., the Internet radio station). Once the user is comfortably listening to the selected media program content (which may be, for example, a song of a rock-n-roll artist), the user may then begin to click on other links related to the artist (e.g., tickets to concerts, biography of the artist, new album of the artist, etc.) while listening to the streaming audio.

In accordance with an alternative embodiment of the present invention, the IIM/S website 220 may also provide a directory of commercial advertisements that a user of the PC system 100 may access and view. The commercial advertisements may take many forms including streaming digital audio, streaming digital video, an HTML web page, etc.

In accordance with an embodiment of the present invention, a radio announcer for the Internet radio station may periodically encourage the user to perform searches using the search tool sub-view 120 and the associated search engine 250 provided by the IIM/S website 220, or to click on other link choices provided by the current sub-view 115.

In accordance with an alternative embodiment of the present invention, the IIM/S website 220 provides an Internet television station, broadcasting streaming video and audio over parts of the Internet 201 that provide enough bandwidth to accommodate the video and audio programming. The Internet television station operates in a similar manner to an Internet radio station (i.e., providing an integrated search engine and/or a directory of commercial advertisements).

The main television programming content picture may be reduced in size and displayed on the screen 130 to a user in a picture-in-picture (PIP)-type window when the user uses the search engine 250 or chooses to view a commercial advertisement. The main display area of the screen 130 is then used to display the resultant search view or the selected commercial advertisement. Alternatively, the search view or commercial advertisement may be displayed in a PIP-type window while the main television programming content picture remains in the main display area of the screen 130. Other user display options are possible as well. The television programming content may include, for example, news video clips or television shows.

As an alternative embodiment, the IIM/S web site 220 may provide an integrated web browser and media player (IWBMP) that can be downloaded to the user's system 100 via the Internet 201. The IWPMP may be customized to have a unique “look and feel”. The IWPMP, once downloaded, is then used to access the streaming digital media program content 240 and the search engine 250 on the IIM/S website 220. The various components of the IIM/S web site (e.g., the streaming media program content 240, the search engine 250, the user interface view 110, and other associated web pages) may be hosted on one or more than one server.

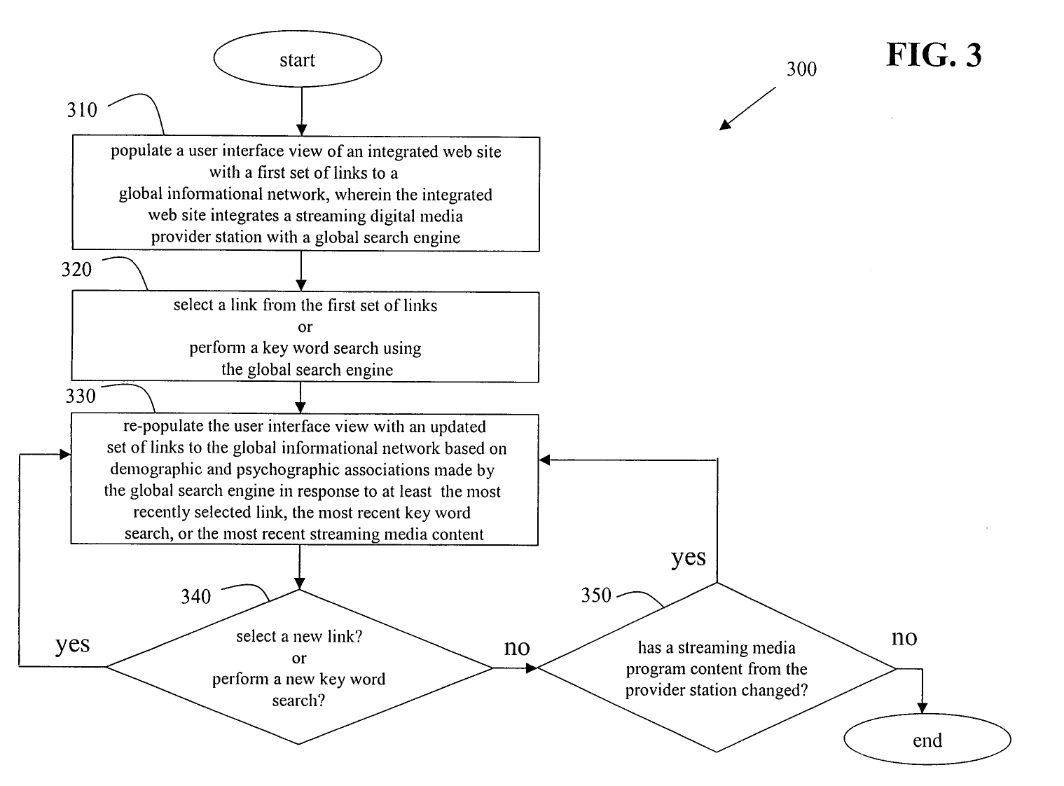

FIG. 3 is a flowchart of an embodiment of a method 300 to provide automatic search capabilities and/or more relevant search results via the search engine 250, based on demographic and/or psychographic associations made by the at least one global search engine in response to the selected links and/or in response to the media program content. As an example, the search engine 250 of system 100 may be configured such that the media content itself is used to populate the interface with search results, which may be for example a first set of links to a global informational network as in step 310. In this embodiment, the digital media provider station is the source of content, but other sources are contemplated, or the system 100 could be integrated into products of various kinds that are in communication with a global information system. In step 320, a link is selected from the first set of links or a key word search is performed using the global search engine. In step 330, the user interface view is re-populated with an updated set of links to the global informational network based on demographic and psychographic associations made by the global search engine in response to at least the most recently selected link, the most recent key word search performed, or the most recent streaming media content. In step 340, a decision is made as to whether or not to select a new link from the updated set of links or to perform a new key word search. If a new link is selected or a new key word search is performed, then the method reverts back to step 330 and re-populates the user interface view with an updated set of links. Otherwise, in step 350, the method checks if a streaming media program content (e.g., a song) from the provider station has changed. If so, then the method reverts back to step 330 and re-populates the user interface view with an updated set of links.

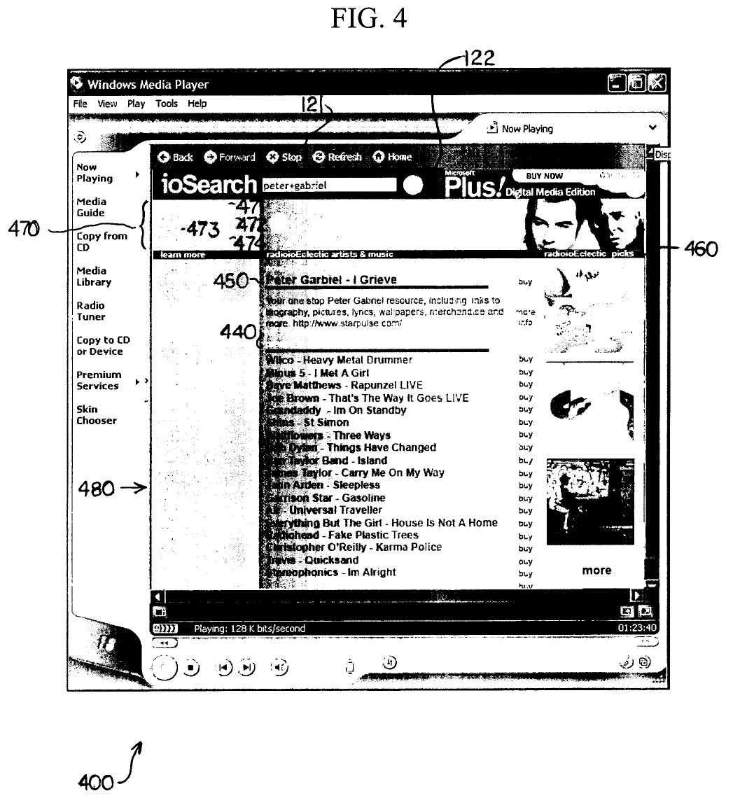

FIG. 4 illustrates a first exemplary embodiment of a IIM/S user interface view 400 provided by the system 200 of FIG. 2, in accordance with various aspects of the present invention. Referring to FIG. 4 to illustrate an example of the method 300 of FIG. 3 using the system 200 of FIG. 2, a user of the system 200 has accessed the IIM/S web site 220 and is listening to streaming digital audio content comprising the Peter Gabriel song “I Grieve” provided by the IIM/S web site 220. The user then enters the search key words “Peter Gabriel” in the text entry window 121 and clicks on the “go” icon 122 to initiate a search. The user interface view 400 is populated with a new set of links including a subset of “learn more” links 430, a subset of “previously played” links 440, a “Peter Gabriel” link 450, a subset of “picks” links 460, and a subset of other links 470 which includes links to “on-line shopping” 471, “music downloads” 472 for purchase, “pets” 473, and “home mortgages” 474. The links are presented in an informative, user-friendly format.

The new set of links populated in the user interface view 400 are generated in response to the search on the key words “Peter Gabriel” by the search engine 250 and sent by the IIM/S web site 220 to the PC 100 to be displayed in the current user interface view 400. The search engine 250 comprises an adaptive global search engine that performs a search of a global informational network (e.g., the Internet 201) in response to the key words “Peter Gabriel” by making predictive demographic and psychographic associations to the lifestyle of the user based on the key words “Peter Gabriel”. The associations are based on trying to predict a specific mood, situation, demographic or other characteristics associated with the type and character of the media content consumed by the user, the searches performed by the user, the sites or other information accessed by the user via the global information system or other characteristics of use of the system 100. As an example, such characteristics may then be used to select a set of products that the current streaming media program content (e.g., current song or artist) invokes to the user, and populates the view 400 accordingly. As the characteristics or types of media content consumed by the user changes, the search engine is adaptive to enhance search results that are more relevant to the user.

As an example, the search engine 250 may be configured to determine that the user is likely interested in “on-line shopping” 471, “music downloads” 472, “pets” 473, and “home mortgages” 474 and populates the view 400 with that subset of links 470 as well as a link 450 to “Peter Gabriel”-specific topics. Also, the search engine 250 determines that the user may want to learn more about other certain “Peter Gabriel”-related topics and populates the view 400 with the subset of links 430. Furthermore, the search engine 250 determines that a user may be interested in other musical picks provided by the integrated web site 220 and populates the view 400 with the subset of links 460. The subset of links 440 is also provided by the integrated web site 220 such that the user can select links associated with the artists and songs (i.e., streaming media program content) most recently streamed by the IIM/S web site 220 onto the Internet 201. The user is provided with many link choices to click on without having to enter key search words at all, or not all the time.

In accordance with an embodiment of the present invention, the demographic and psychographic associations performed by the adaptive search engine 250 are accomplished in real time using adaptive inference techniques. In accordance with an alternative embodiment of the present invention, the demographic and psychographic associations performed by the adaptive search engine 250 are accomplished in real time using a set of predetermined association rules.

Other association techniques are possible as well, in accordance with various embodiments of the present invention. For example, resultant associations are predetermined based on potential user actions with the user interface view 400 and the adaptive search engine 250 is programmed accordingly. In accordance with an embodiment of the present invention, at least some of the resultant links that get re-populated in a user interface view are links to web sites of paying sponsors of the IIM/S web site 220.

In accordance with an embodiment of the present invention, identification data known as ID3 and/or ID4 tag data are read and used as inputs to the search engine 250 to make the associations. ID3 and/or ID4 tag data comprise information such as song title, artist, album, year, genre, and comments. ID3 and/or ID4 data are attached to files of media content.

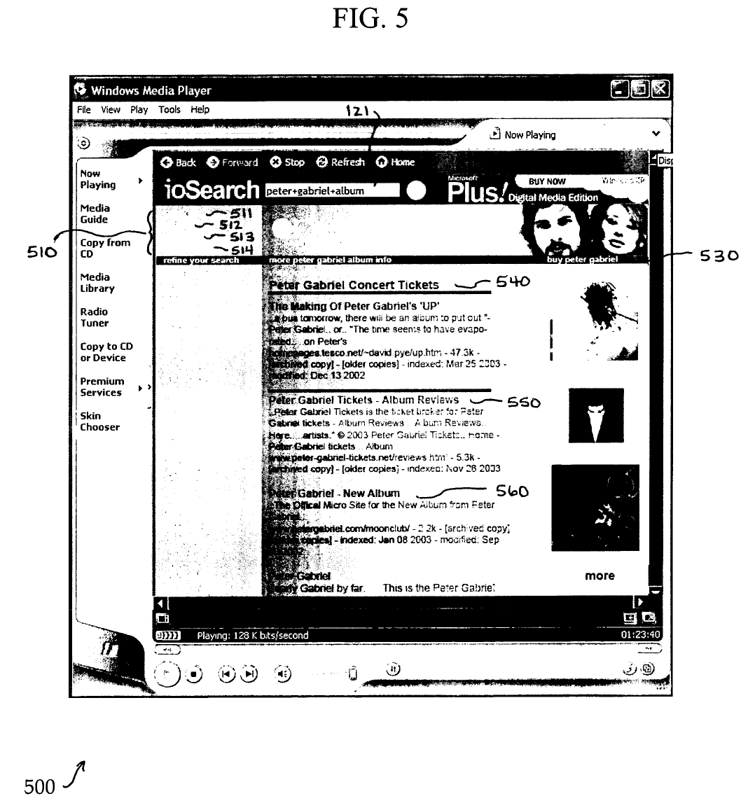

FIG. 5 illustrates a second exemplary embodiment of a IIM/S user interface view 500 provided by the system 200 of FIG. 2, in accordance with various aspects of the present invention. Continuing with the example, the user clicks on the “albums” link 480 in the “learn more” subset of links 430. As a result, referring to FIG. 5, the view 400 is re-populated with a new set of links shown in the updated user interface view 500. As a result, the search engine 250 determines that the user is likely interested in “auctions” 511, “autos” 512, “hot jobs” 513, and “real estate” 514 and populates the view 500 with that subset of links 510. Also, the search engine 250 determines that the user may want to refine his search about album-related topics and populates the view 500 with the subset of links 520. Furthermore, the search engine 250 determines that a user may be interested in buying certain Peter Gabriel albums (e.g., CD's) and populates the view 500 with the subset of links 530 which provides links to a selection of Peter Gabriel albums for purchase. The view 500 is also populated with a link 540 to “Peter Gabriel concert tickets”, a link 550 to “album reviews”, and a link 560 to “Peter Gabriel's new album”. Other links may be provided as well, in accordance with various embodiments of the present invention.

The links populated in the view 500 are a result of the adaptive search engine 250 making predictive demographic and psychographic associations to the lifestyle of the user in response to having clicked on the “album” link 480 and/or having searched on the key words “Peter Gabriel”. In accordance with an embodiment of the present invention, when a user clicks on the “albums” link 480, the text in the text entry window 121 is updated just as if a paid search were performed (i.e., in effect, a paid search has been performed by clicking on the link 480).

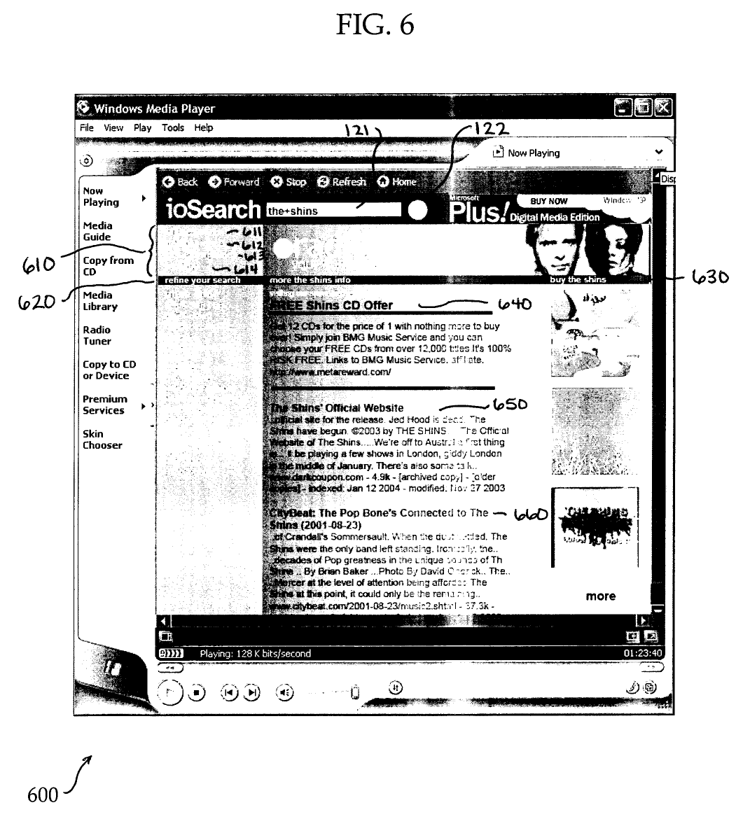

FIG. 6 illustrates a third exemplary embodiment of a IIM/S user interface view 600 provided by the system 200 of FIG. 2, in accordance with various aspects of the present invention. Continuing with the example, referring to FIG. 6, the user enters the key words “the shins” in the text entry window 121 and clicks on the “go” icon 122 to initiate a new search. As a result, the view 500 is re-populated with a new set of links shown in the updated user interface view 600. As a result, the search engine 250 determines that the user is likely interested in “airline tickets” 611, “car insurance” 612, “Disney vacations” 613, and “casinos” 614 and populates the view 600 with that subset of links 610. Also, the search engine 250 determines that the user may want to refine his search about “the shins”-related topics and populates the view 600 with the subset of links 620. Furthermore, the search engine 250 determines that a user may be interested in buying certain albums of “the shins” and populates the view 600 with the subset of links 630 which provides links to a selection of albums of “the shins”. The view 600 is also populated with a link 640 to “FREE Shins CD Offer”, a link 650 to “The Shins' Official Website”, and a link 660 to “City Beat: The Pop Bone's Connected to The Shins (2001-08-23)”. Other links may be provided as well, in accordance with various embodiments of the present invention.

The links populated in the view 600 may be the result of the adaptive search engine 250 making predictive demographic and psychographic associations to the lifestyle of the user in response to having searched on the key words “the shins” and/or having clicked on the “album” link 480 and/or having searched on the key words “Peter Gabriel”, and/or using information related to the types or characteristics of the media content consumed by the user.

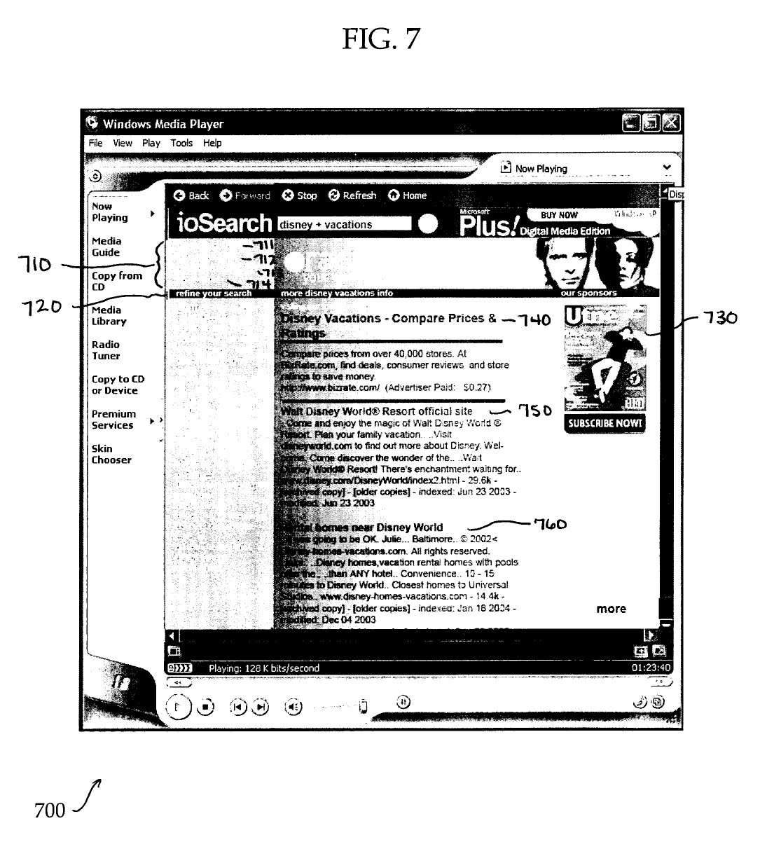

FIG. 7 illustrates a fourth exemplary embodiment of a IIM/S user interface view 700 provided by the system 200 of FIG. 2, in accordance with various aspects of the present invention. Continuing with the example, the user clicks on the “Disney vacations” link 613. As a result, referring to FIG. 7, the view 600 is re-populated with a new set of links shown in the updated user interface view 700. As a result, the search engine 250 determines that the user is likely interested in “Orlando hotels” 711, “cheap airfare” 712, “paramount studios” 713, and “sea world” 714 and populates the view 700 with that subset of links 710. Also, the search engine 250 determines that the user may want to refine his search about “Disney vacations”-related topics and populates the view 700 with the subset of links 720. Furthermore, the search engine 250 determines that a user may be interested in subscribing to a magazine and populates the view 700 with a link 730 to a magazine which sponsors the IIM/S web site 220. The view 700 is also populated with a link 740 to “Disney Vacations—Compare Prices & Ratings”, a link 750 to “Walt Disney World Resort official site”, and a link 760 to “Rental homes near Disney World”. Other links may be provided as well, in accordance with various embodiments of the present invention.

The links populated in the view 700 are a result of the adaptive search engine 250 making predictive demographic and psychographic associations to the lifestyle of the user in response to having clicked on the “Disney vacations” link 613 and/or having searched on the key words “the shins” and/or having clicked on the “album” link 480 and/or having searched on the key words “Peter Gabriel”, and/or using information related to the types or characteristics of the media content consumed by the user.

Continuing with the example, the Peter Gabriel song “I Grieve”, being streamed from the IIM/S web site 220 to the PC 100 via the Internet 201, finishes playing on the system 100 and a “new song” by a new artist begins streaming to the system 100 from the IIM/S website 220. As a result, the view 700 is re-populated with a new set of links (not shown) by the adaptive search engine 250 based on making predictive demographic and psychographic associations to the lifestyle of the user in response to the “new song” being streamed to the user and/or having clicked on the “Disney vacations” link 613 and/or having searched on the key words “the shins” and/or having clicked on the “album” link 480 and/or having searched on the key words “Peter Gabriel”.

In accordance with an embodiment of the present invention, a user identifies themself to the IIM/S website 220 by logging in to the website 220. As a result, the website 220 can keep track of the user's listening habits and search habits over a long period of time. The search engine 250 can make associations based on such a user history.

In accordance with an embodiment of the present invention, the user of the system 200 may provide certain demographic information to the IIM/S web site 220 such as the user's age, the user's gender, and the user's zip code, for example. Other demographic information may be provided as well. The adaptive search engine 250 can use the user-provided demographic information as part of making predictive demographic and psychographic associations to determine which links to re-populate into the user interface view 110.

In accordance with an alternative embodiment of the present invention, the IIM/S web site 220 may employ more than one search engine 250 to perform the predictive demographic and psychographic associations and searches.

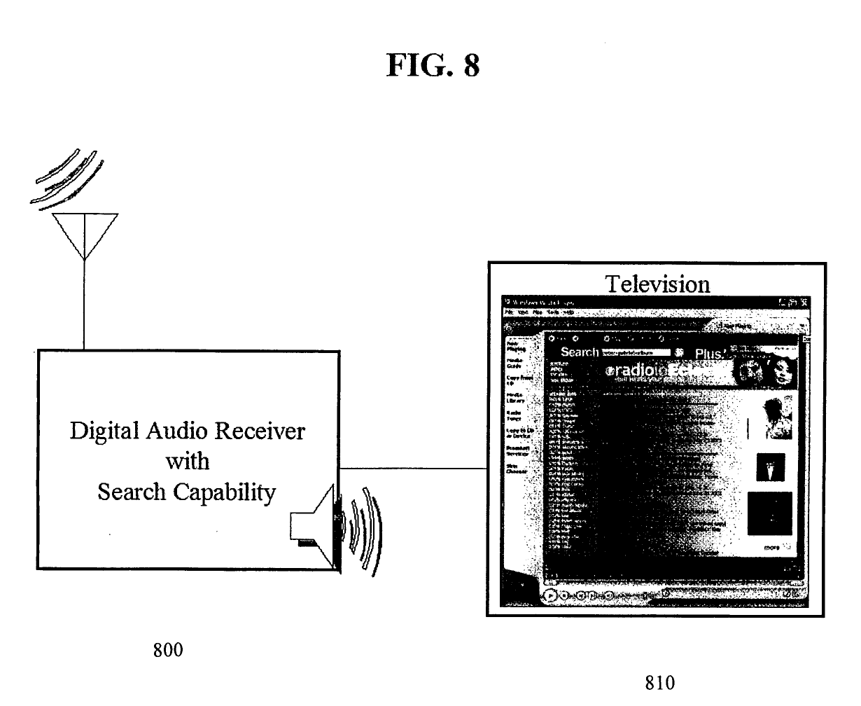

An alternative embodiment is shown in FIG. 8, wherein an integrated media/search capability is provided in association with other devices, such as “non-computer” types of devices such as a digital media receiver/player 800. The digital media receiver/player 800 may simply be connected to a TV or monitor 810, to allow access to menus or other graphic/text information, or may include its own display. The interface with digital media receiver 800 and search capabilities may be faciliated by a remote control device, keyboard, or any suitable control device. The digital media receiver/player 800, may therefore receive digital media, and the systems and methods of the invention provided to allow search capabilities as described with reference to previous embodiments. Alternatively, digital media receiver/player 800 may be integrated directly into the TV 810 if desired. Similarly, it should be clear that the invention is also capable of being implemented on a wide variety of devices which would allow both media content and access to search capabilities via a global information system. Thus, any other suitable device for integration of media consumption with communication to a global information system and search engine application is contemplated in the invention. For example, any existing or future device, application, executable file, computer of any form factor, cellular devices, PDA, digital audio player and/or receiver, television, wireless media receivers, digital media managers and the like are contemplated.

In summary, methods and systems to integrate media consumption/search capabilities are provided. The methods rely on an adaptive search engine which uses demographic and psychographic associations to the user in order to determine more relevant search resyults to the user based on the types or characteristics of the media consumed by the user, or based on other demographic and psychographic associations to the user based on the user actions and use of the system.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to automatically search a global informational network, based on media content consumed by a user of the network, comprising the steps of:
allowing access to and consumption of at least one media content file accessible via the network;
automatically conducting a search of the network based upon at least the media content being consumed by the user; and
communicating information relating to the search via a user interface.

2. The method of claim 1 wherein:
said search of the global informational network is based on demographic and psychographic associations made by at least one global search engine in response to the media consumed by the user.

3. The method of claim 2 wherein said search engine is provided via a integrated site accessible via the global informational system, and provides a plurality of links to at least one of streaming media program content, other information within said integrated site, other sites accessible via the global informational system, and combinations thereof.

4. The method of claim 3 wherein said associations are predetermined and pre-programmed into said at least one global search engine before any links are selected.

5. The method of claim 2 wherein said associations are determined in real time by said at least one global search engine as the user selects links.

6. The method of claim 5 wherein said at least one global search engine determines said associations in real time using adaptive inference techniques.

7. The method of claim 5 wherein said at least one global search engine determines said associations in real time using a set of predetermined association rules.

8. The method of claim 3 wherein said integrated site is accessed via said global informational network using a personal computer (PC) system, having a browser connected to said global informational network.

9. The method of claim 8 wherein said PC system includes a media player to play said media content.

10. The method of claim 1 wherein said at least one media content file is provided as streaming digital media.

11. The method of claim 10 wherein said streaming digital media is selected from the group consisting of streaming digital video, streaming digital audio or combinations thereof.

12. The method of claim 1 wherein said user interface includes a key word search text entry box and an icon to initiate a search on entered key search words.

13. The method of claim 11 wherein said streaming media content is provided by a source selected from the group consisting of an Internet radio station with integrated search capability provided by said integrated global search engine, an Internet television station with integrated search capability provided by said integrated global search engine or combinations thereof.

14. The method of claim 3 wherein said search provides information relating to at least one paying sponsor of said integrated site.

15. The method of claim 1 further comprising:
collecting first demographic information from a user via said global informational network; and
re-populating said user interface view with a links to said global informational network based on demographic and psychographic associations made by said at least one global search engine in response to at least said collected first demographic information.

16. The method of claim 15 further comprising:
collecting second demographic information from a user of said integrated web site via said global informational network; and
re-populating said user interface view with links to said global informational network based on demographic and psychographic associations made by said at least one global search engine in response to at least said collected second demographic information.

17. The method of claim 16 wherein each of said first and second demographic information includes at least one of a user's age or age range, a user's zip code, and a user's gender.

18. A method to provide an integrated media/search system, said method comprising:
providing an integrated system with a communication system and processing to communicate with a global informational network, and a media processing system, wherein said integrated system includes at least one global search engine and a user interface; and
populating said user interface with at least a first set of links to said global informational network, upon entering at least one search into said search engine, based on demographic and psychographic associations made by said at least one global search engine in response to said at least one first search.

19. The method of claim 18 further comprising:
selecting a first link from said second set of links; and
re-populating said user interface view with a third set of links to said global informational network based on demographic and psychographic associations made by said at least one global search engine in response to said selected first link.

20. The method of claim 18 wherein said links comprise links to at least one of streaming media program content, other information in said integrated system, other web sites, and combinations thereof.

21. The method of claim 18 wherein said associations are made in real time by said at least one global search engine as each search is performed.

22. The method of claim 18 wherein said at least one global search engine makes said associations in real time using adaptive inference techniques.

23. The method of claim 18 wherein said at least one global search engine makes said associations in real time using a set of predetermined association rules.

24. The method of claim 18 wherein said communication system includes a browser connected to the global informational network.

25. The method of claim 18 wherein said integrated system is a web site accessed via said global informational network.

26. The method of claim 18 wherein said system includes a media player adapted to play streaming media program content.

27. The method of claim 26 wherein said streaming digital media program content is provided by an Internet radio station providing streaming digital audio, an Internet video station providing streaming digital video, and combinations thereof.

28. The method of claim 18 wherein said links include at least one link to a web site of at least one paying sponsor of said integrated system.

29. A system for providing search of a global informational network to provide enhanced search results, comprising: a user interface, a communication system for connection to the global informational network and a processing system for at least media content and a search engine in communication with the global informational network, wherein upon a user consuming media content via the interface, and/or making queries to the search engine, the system captures and considers demographic and psychographic information based on a user's use of the search engine and based upon the media consumed via the interface.

30. The system according to claim 29, wherein the system populates the user interface view with links to the global informational network from the associations in response to the selected links and/or in response to the media program content.

31. The system of claim 29 wherein the processing system collects first demographic information from a user of said integrated web site via said global informational network, and populates the user interface view with links to said global informational network based on demographic and psychographic associations made by said at least one global search engine in response to at least said collected first demographic information.

32. A method to provide an integrated media/search application, comprising the steps of:
providing at least one streaming media source in communication with a user interface,
providing a search engine in communication with a global informational network through the interface, the search engine providing search results to the interface based on demographic and psychographic associations made by the at least one global search engine in response to search queries and/or in response to the media program content consumed by the user via the system.

33. The method according to claim 32, further comprising populating the user interface view with a first set of links to the global informational network in response to the type or characteristics of the streaming media content.

34. The method according to claim 33, further comprising re-populating the user interface view with further links to the global informational network based on demographic and psychographic associations made by the global search engine in response to different streaming media content.
